(19) United States
(12) Patent Application Publication
(10) Pub. No.: US 2016/0148243 A1
(43) Pub. Date: May 26, 2016

(54) METHOD AND APPARATUS FOR INCENTIVIZING TRUTHFUL DATA REPORTING

(71) Applicant: THOMSON LICENSING, Issy les Moulineaux (FR)

(72) Inventors: Efstratios Ioannidis, Boston, MA (US); Rachel Cummings, Los Altos, CA (US)

(21) Appl. No.: 14/949,997

(22) Filed: Nov. 24, 2015

Related U.S. Application Data
(60) Provisional application No. 62/084,240, filed on Nov. 25, 2014.
(60) Provisional application No. 62/133,499, filed on Mar. 16, 2015.

(51) Int. Cl. G06Q 30/02

(52) U.S. Cl. CPC G06Q 30/0236

(57) ABSTRACT

A method and an apparatus for generating a privacy-preserving behavior predictor with incentive are provided, derived from verifiable and non-verifiable attributes from a plurality of agents. The privacy-preserving behavior predictor is based on regression (e.g., ridge-regression), is ε-differentially private and the incentive in the form of payments to each agent are ε-jointly differentially private. A method and an apparatus for generating a recommendation are also provided, derived from verifiable attributes from an agent and the ε-differentially private behavior predictor with incentive.

### CROSS-REFERENCE TO RELATED APPLICATIONS

This application claims the benefit of and priority to the U.S. Provisional Patent Applications: Ser. No. 62/084240 and titled “METHOD AND APPARATUS FOR INCENTIVIZING TRUTHFUL DATA REPORTING”, filed on Nov. 25, 2014, and Ser. No. 62/133499 and titled “METHOD AND APPARATUS FOR INCENTIVIZING TRUTHFUL DATA REPORTING”, filed on Mar. 16, 2015. The provisional applications are expressly incorporated by reference herein in their entirety for all purposes.

### TECHNICAL FIELD

The present principles relate to privacy-preserving techniques and statistical inference, and in particular, to providing incentives to agents for truthfully reporting their data for inference purposes.

### BACKGROUND

In the era of “Big Data”, the collection and mining of user data has become a fast growing and common practice by a large number of private and public institutions. The statistical analysis of personal data has become a cornerstone of several experimental sciences, such as medicine and sociology. Studies in these areas typically rely on experiments, drug trials, or surveys involving human subjects. Government agencies rely on data to address a variety of challenges, e.g. national security, national health, budget and fund allocation; medical institutions, analyze data to discover the origins and potential cures to diseases; financial institutions and universities analyze financial data for macro and micro economics studies. Data collection has also recently become a commonplace but controversial aspect of the Internet economy: companies such as Google, Amazon and Netflix maintain and mine large databases of behavioral information (such as, e.g., search queries or past purchases) to profile their users and personalize their services. In turn, this has raised privacy concerns from consumer advocacy groups, regulatory bodies, as well as the general public.

Statistical inference techniques are used to test hypotheses and make estimations using sample data from these databases. However, in some cases, the collection, the analysis, or the sharing of a user's data with third parties is performed without the user's consent or awareness. In other cases, data is released voluntarily by a user to a specific entity, in order to get a service in return, e.g. product ratings released to get recommendations. In either case, privacy risks arise as some of the collected data may be deemed sensitive by the user (e.g. political convictions, health status, income level, etc.), or may seem harmless at first sight (e.g. product ratings), yet lead to the inference of more sensitive data with which it is correlated. The latter threat refers to an inference attack—inferring private data by exploiting its correlation with publicly released data.

In the past, various ad-hoc approaches to anonymizing public records have failed when researchers managed to identify personal information by linking two or more separately innocuous databases. Two well-known instances of successful inference attacks have been the Netflix database and the Massachusetts Group Insurance Commission (GIC) medical encounter database. In the Netflix case, A. Narayanan and V. Shmatikov linked the Netflix anonymized training database with the Imdb database (using the date of rating by a user) to partially de-anonymize the Netflix training database. In the GIC case, L. Sweeney from Carnegie Mellon University linked the anonymized GIC database (which retained the birthdate, sex, and zip code of each patient) and voter registration records to identify the medical record of the governor of Massachusetts. This threat to people's privacy has generated a great deal of interest in secure ways to perform statistical inference.

A statistic is a quantity computed from a sample. If a database is a representative sample of an underlying population, the goal of a privacy-preserving statistical database is to enable the user to learn properties of the population as a whole, while protecting the privacy of the individuals in the sample. Recently, the proposal of techniques such as differential privacy, in the seminal paper “Calibrating Noise to Sensitivity in Private Data Analysis” by C. Dwork, F. McSherry, K. Nissim, and A. Smith, has spurred a flurry of research, based on the notion that, for neighboring databases which differ only in one element, or row, no adversary with arbitrary auxiliary information can know if one particular participant submitted their information.

An issue remains that no privacy-preserving technique is immune to attacks. As a result, more and more the desire for privacy incentivizes individuals to lie about their private information or, in the extreme, altogether refrain from any disclosure. For example, an individual may be reluctant to participate in a medical study collecting biometric information, concerned that it may be used in the future to increase their insurance premiums. Similarly, an online user may not wish to disclose their ratings to movies if this information is used to infer, e.g., their political affiliation. On the other hand, the statistical analysis over personal data is clearly beneficial to both science (and thus, the public at large) as well as to companies whose services and revenue streams crucially rely on mining behavioral data.

It is therefore of interest to investigate ways to incentivize users (hereby also called agents or players) to truthfully report their data. The present principles provide a method by which analysts who wish to perform a statistical task on the user data can provide such incentive to the user.

### SUMMARY

According to one aspect of the present principles, a method of generating a privacy-preserving behavior predictor with incentives is provided, the method including: receiving verifiable and reported non-verifiable attributes for each agent of a plurality of agents; generating a first behavior predictor based on regression over the attributes; generating an ε-differentially private behavior predictor by adding noise to the first behavior predictor; generating an ε-jointly differentially private payment; and providing the ε-jointly differentially private payment to each agent and the ε-differentially-private behavior predictor.

According to one aspect of the present principles, an apparatus for generating a privacy-preserving behavior predictor with incentives is provided, the apparatus including a processor in communication with at least one input/output interface; and at least one memory in communication with the processor, the processor being configured to: receive verifiable and reported non-verifiable attributes for each agent of a plurality of agents; generate a first behavior predictor based on regression over the attributes; generate an ε-differentially private behavior predictor by adding noise to the first behavior predictor; generate an ε-jointly differentially private payment; and provide the ε-jointly differentially private payment to each agent i and the ε-differentially-private behavior predictor.

According to one aspect of the present principles, a method of recommendation is provided, the method including: receiving verifiable attributes from an agent; receiving or generating an ε-differentially private behavior predictor with incentive according to any of the methods of generating an ε-differentially private behavior predictor with incentive of the present principles; and generating a recommendation based on the verifiable attributes and the behavior predictor.

According to one aspect of the present principles, an apparatus for generating a recommendation is provided, the apparatus including a processor in communication with at least one input/output interface; and at least one memory in communication with the processor, the processor being configured to: receive verifiable attributes from an agent; receive or generate an ε-differentially private behavior predictor with incentive according to any of the methods of generating an ε-differentially private behavior predictor with incentive of the present principles; and generate a recommendation based on the verifiable attributes and the behavior predictor.

Additional features and advantages of the present principles will be made apparent from the following detailed description of illustrative embodiments which proceeds with reference to the accompanying figures.

### BRIEF DESCRIPTION OF THE DRAWINGS

The present principles may be better understood in accordance with the following exemplary figures briefly described below:

FIG. 1 illustrates a flowchart of a method of generating a privacy-preserving behavior predictor with incentive according to the present principles.

FIG. 2 illustrates a flowchart of a method of recommendation according to the present principles.

FIG. 3 illustrates a block diagram of a computing environment utilized to implement the methods of the present principles.

### DETAILED DISCUSSION OF THE EMBODIMENTS

In accordance with the present principles, a technique is provided for determining how an analyst performing regression should compensate strategic agents so that they reveal their data truthfully, despite privacy concerns.

The present principles may be implemented in any setting where an analyst wants to perform computations on or estimate distributional properties of data held by strategic agent with privacy concerns, and the analyst has the capabilities to provide some kind of a payment in exchange for the data. One example would be for the purposes of recommendations given by a service provider. The verifiable vector xᵢ can be, for example, the movies that have been rented or purchased by a user in the past. The unknown data yᵢ can be how likely the user is to rent or purchase a particular movie title (or a movie from a particular genre/actor/director/etc.), or to rent/purchase a movie in the next 30 days, etc.

According to the present principles, n entities are considered, henceforth termed players or agents, holding data to be given to an analyst (e.g., a service provider), who is to perform regression over this data. Each player i has a vector of verifiable attributes xᵢ ∈ [symbol] ^{d} (i.e., attributes for which the player cannot lie, like gender, age, etc.), and a single non-verifiable private attribute yᵢ ∈ [symbol] ^{d} (i.e., the rank to a movie, their predisposition to vote for a candidate, or the presence of some substance in their blood). An extension to multiple such attributes is immediate. The latter (non-verifiable) attributes can be manipulated by the players prior to their disclosure to the analyst. Thus, each player i knows their own (xᵢ, yᵢ), but does not know that of player j. As is standard in linear regression, it is assumed that the yᵢ are linearly related to the xᵢ's, i.e., there exists a common vector θ ∈ [symbol] ^{d} such that:

yᵢ=θ^{T}xᵢ+zᵢ (1)

where zᵢ, i=1, . . . , n, are independent and identically distributed (i.i.d.) zero mean variables. As is standard in linear regression, the analyst's goal is to estimate θ from the player's data.

In particular, the analyst aims to learn θ by performing a regression on the xᵢ's and yᵢ's collected from all players: that is, each player i is asked to report their data (xᵢ, yᵢ). The xᵢ's are observed by the analyst (but not by other players), and players cannot misreport their xᵢ's. Equivalently, the analyst can verify the correct values if it is desirable. The yᵢ's are not verifiable, so players may actually report a \tilde{y}ᵢ's that need not equal their true yᵢ's. Given these reports, the analyst will perform a linear regression on the true xᵢ's and the (not necessarily truthfully) reported \tilde{y}ᵢ's to estimate θ. This estimate is hereby called \hat{θ}.

A skilled artisan will appreciate that the estimate θ may be seen as a behavior predictor, that is, a metric which defines a user potential behavior or qualities as a function of their attributes. If calculated based on a large set of users and attributes, θ can be seen as an independent predictor and may be used to predict non-verifiable private attributes for any other users. It may also be used to predict a correct non-verifiable private attribute for a user which lied. As such, there is a utility in learning θ alone, as it may be used to predict private non-verifiable attributes of general users based on their verifiable and public attributes, with application, e.g., in general marketing, commerce, banking and technology (including artificial intelligence and robotics). It is therefore of interest that the estimate \hat{θ} be as close as possible to θ, hence the importance of the incentives.

The data (xᵢ, yᵢ) is sensitive information, so players may incur some disutility from privacy loss by revealing their data to the analyst. These losses are captured with a player-specific privacy cost cᵢ * ε, where cᵢ>0 captures the player's sensitivity to the privacy violation and ε>0 corresponds to a differential-privacy guarantee provided by the analyst. The relative costs cᵢ>0 are not revealed to the analyst.

To offset these costs, the analyst provides each player i a payment πᵢ≧0 based upon their own report (xᵢ, \tilde{y}ᵢ) and the estimated parameter \hat{θ}. It is assumed that players have quasi-linear utility functions, i.e., the utility of each player is:

U=πᵢ−cᵢ*ε (2)

where πᵢ is the payment made to player i by the mechanism and cᵢ * ε is the cost incurred by revealing the data of the analyst. An agent who receives payment πᵢ and experiences privacy cost for participating in an ε-differentially private computation will enjoy utility as in equation (2).

The payment in question can be money or another monetary equivalent (e.g. gift cards, discounts on future purchases, entry into a raffle for a prize, etc.). It can also be a non-monetary payment through free or improved quality services provided by the data analyst. Many online companies that collect consumer data (e.g. Google, Facebook, etc.) provide customers with a free service in exchange for their data. Other companies are able to provide a higher quality user experience to customers who share data, using data-driven personalization. For example, companies such as Netflix or Amazon are able to provide better recommendations to customers who give accurate ratings of other products/movies.

It is assumed that the parameter θ, is drawn from a distribution [symbol] , with support such that ∥θ∥₂²≦B for some finite B that does not grow with n. The true parameter θ and realizations of the noise terms zᵢ are unknown to both the analyst and the players. It is also assumed that the xᵢ are independent and identically distributed (i.i.d.) draws from the uniform distribution on the d-dimensional unit ball. In addition, it is also assumed that the zᵢ are i.i.d. draws from commonly known distribution G, with mean zero, finite variance σ², and supp(G)=[−M,M] for some finite M that also does not grow with n (e.g., truncated Gaussian or Laplacian). These assumptions together imply that |θ^{T}xᵢ|≦B and |yᵢ|≦B+M.

According to the present principles, a method is provided for generating a behavior predictor with incentives. An embodiment of the present principles includes a protocol described below. It receives as input (a) the (xᵢ, \tilde{y}ᵢ) by each player i and produces as output: (a) an estimate \hat{θ} of θ, as well as (b) a set of payments πᵢ, one for each player i=1, . . . , n. Specifically, the analyst performs the following tasks:

1. Solicits reports x ∈ ( [symbol] ^{d})ⁿ and \tilde{y} ∈ ( [symbol] U {⊥}))ⁿ, that is, it solicits and receives from each player or agent i the set of verifiable and non-verifiable attributes (xᵢ, \tilde{y}ᵢ) for a plurality n of players, wherein a player may misreport their non-verifiable attribute yᵢ.

2. Using these values, it first estimates θ through a regression algorithm. In an exemplary embodiment, it utilizes the so-called ridge-regression, with a regularization parameter λ. The corresponding estimate is hereby called [symbol] and defined by:

[symbol]

=(λI+X^{T}X)⁻¹X^{T}\tilde{y} (3)

where X is the matrix for which each row corresponds to xᵢ of each agent/player and I is the identity matrix of order n. The regularizing parameter λ is used as a trade off between privacy of the inputs and accuracy of the output. As λ increases, the privacy of the data increases, but the output becomes more inaccurate; when λ becomes small, the converse happens, i.e., privacy is lost. In linear regression, λ=0. Despite the fact that this would give the most accurate regression on the reported data, strategic agents with privacy concerns would misreport their data to such a mechanism because it cannot offer good privacy guarantees.

3. Adds to [symbol] an appropriately selected random vector υ representing noise. In general, the vector may be drawn from different distribution functions, e.g., Laplace, Gaussian or even a pseudo-random number generator (created by a shift register mechanism). For example, it draws vector υ ∈ [symbol] ^{d} with probability proportional to

$$exp ( \frac{- λ ɛ}{8 * B + 4 * M} {‖ v ‖}_{2} ) ,$$

where ∥.∥₂ stands for the L2 or vector norm operator. This probability distribution, is a high-dimensional analog of a Laplacian distribution, and is used to satisfy the formal guarantee of ε-differential privacy. The output estimator is as follows:

\hat{θ}^{P}= [symbol] +υ (4)

In the case of a Laplacian distribution, the sensitivity of the computation of \hat{θ}^{P}, or the maximum amount by which it can change (with respect to the L2-norm) if a single agent changes their report, is

$$\frac{8 * B - 4 * M}{λ} .$$

4. Pay each agent i, the quantity:

πᵢ=B_{a,b}((\hat{θ}^{P})^{T}xᵢ,E[θ|xᵢ, \tilde{y}ᵢ]^{T}xᵢ) (5)

where E[θ|xᵢ, \tilde{y}ᵢ]^{T} is the expectation of a random predictor θ conditioned on the player's reported data and E[θ|xᵢ, \tilde{y}ᵢ]^{T}xᵢ can be seen as a measure of truthfulness against which the non-verifiable private attribute is going to be compared. The random predictor θ is drawn from a distribution [symbol] , with support such that ∥θ∥₂²≦B for some finite B that does not grow with n. This can include truncated Gaussian, uniform on a finite set, truncated exponential, etc. The true parameter θ and realizations of the noise terms zᵢ are unknown to both the analyst and the players. It is also assumed that the xᵢ are independent and identically distributed (i.i.d.) draws from the uniform distribution on the d-dimensional unit ball. In addition, it is also assumed that the \tilde{y}ᵢ satisfy equation (1) and the zᵢ are i.i.d. draws from commonly known distribution G, with mean zero, finite variance σ², and supp(G)=[−M, M] for some finite M that also does not grow with n (e.g., truncated Gaussian or Laplacian). These assumptions together imply that |θ^{T}xᵢ|≦B and |yᵢ|≦B+M. In an exemplary embodiment, the truthfulness score B_{a,b} is an adaptation of the Brier score for the problem at hand. It is a rescaled version, designed as a affine transformation (i.e. shifted and scaled) of the Brier scoring rule, given by:

B_{a,b}(p,q)=a−b*(p−2pq+q²) (6)

where a corresponds to the shifting, and the b corresponds to the scaling. The Brier scoring rule was originally designed for predicting binary events (e.g., will it rain tomorrow?), where p is an indicator variable (i.e. either 0 or 1) indicating whether it rained, and q is the agent's reported probability that it will rain. When p and q lie between 0 and 1, using Brier scoring as a payment rule ensures that all players receive positive payments. Once p and q lie outside that range, such a promise no longer holds. The shifting and scaling parameters are improvements on the Brier score required to ensure that (i) payments are always positive, (ii) payments compensate agents for their privacy-cost, and (iii) the deviation term δ(n)→0. The Brier scoring rule is one particular example of a Proper Scoring Rule (PSR), which are scoring rules from the prediction markets that are uniquely maximized by truthful reporting on the part of the agents. According to the present principles, the B_{a,b} function can be extended to affine transformations of other PSR's.

A skilled artisan will appreciate that the present principles have the following important properties:
a. The output estimate \hat{θ}^{P} of the algorithm is ε-differentially private and the payment πᵢ is ε-jointly differentially private.
b. The payment that each player receives is such that every user is incentivized to be truthful: the value \tilde{y}ᵢ that maximizes their utility differs from their truthful yᵢ by no more than a deviation term δ(n), where δ(n)→0 as n increases towards infinity.
c. The accuracy of the computed estimation of θ is optimal, that is, the estimation attains the smallest possible error E[|θ−\hat{θ}^{P}|²], as n goes to infinity.

The ε-differential privacy promises that if one player changes their report, the distribution over outputs of the mechanism should be close to the original distribution over outputs, where close means within an e^{ε} multiplicative factor. Thus, it bounds the sensitivity of the output to any one player's report. Formally, one may consider a trusted party that holds a dataset of sensitive information (e.g. medical records, voter registration information, email usage) with the goal of providing global, statistical information about the data publicly available, while preserving the privacy of the users whose information the data set contains. Such a system is called a statistical database. The notion of indistinguishability, later termed Differential Privacy, formalizes the notion of “privacy” in statistical databases.

Formally, a randomized algorithm [symbol] is ε-differentially private if for all datasets [symbol] ₁ and [symbol] ₂ that differ on a single element (i.e., data of one person), and all subsets S⊂Range( [symbol] ),

Pr[ [symbol] ( [symbol] ₁∈S)]≦e^{ε}*Pr[ [symbol] ( [symbol] ₂∈S)] (7)

where the probability Pr[·] is taken over the coins of the algorithm and Range( [symbol] )denotes the output range of the algorithm [symbol] . This means that for any two datasets which are close to one another (that is, which differ on a single element) a given differentially private algorithm [symbol] will behave approximately the same on both data sets. The definition gives a strong guarantee that the presence or absence of an individual will not affect the final output of the query significantly. Differential Privacy is a condition on the release mechanism and not on the dataset.

Joint differential privacy is a slight relaxation of the (regular) differential privacy, but is only well-defined in certain settings: when the output of the mechanism can be divided up into n parts, one for each player, and the i-th player only sees the i-th part of the output. According to the present principles, the payment vector π consists of n payments, where player i only sees their own payment πᵢ, and doesn't see the payments made to other players. Conversely, a skilled artisan will appreciate that one cannot refer to the estimate \hat{θ}^{P} as being jointly differentially private because it can't be broken up into disjoint parts for each player.

According to the present principles, joint differential privacy means that if one player changes their report, the joint distribution over payments to all the players other than themselves won't change by more than a multiplicative e^{ε} factor. However, there is no restriction on how much their own payment can change. Thus, according to the present principles, the sensitivity of everyone else's payments in their report is bounded, but their own payment can be arbitrarily sensitive in their own report. This allowance for their own payment is important in settings where there is concern with the incentives of strategic players. If (regular) differential privacy is used instead, then each player's own payment would be (approximately) independent of their report, so the player would have very little incentive to be truthful.

Formally, a randomized algorithm [symbol] is ε-jointly differentially private if for all datasets [symbol] ₁ and [symbol] ₂ that differ on a single element (i.e., data of one person), and all subsets S⊂Range( [symbol] ),

Pr[ [symbol] (( [symbol] ₁)₋ᵢ∈S)]≦e^{ε}*Pr[ [symbol] (( [symbol] ₂)₋ᵢ∈S)] (8)

where [symbol] (( [symbol] ₁)₋ᵢ means the parts of the output from algorithm [symbol] due to all players other than player i, when the algorithm is run on database [symbol] ₁.

A skilled artisan will appreciate that the framework of differential privacy paired with proper scoring rules to incentivize truthfulness is not restricted to ridge-regression and may be applicable to a broad range of regression techniques. Indeed, it can be applied to any regression technique for which (1) the norm of the bias of the estimator, and (2) the trace of the covariance matrix of the estimator are both diminishing as the number of players grows large. I don't have a complete understanding of what regression techniques fall into this category.

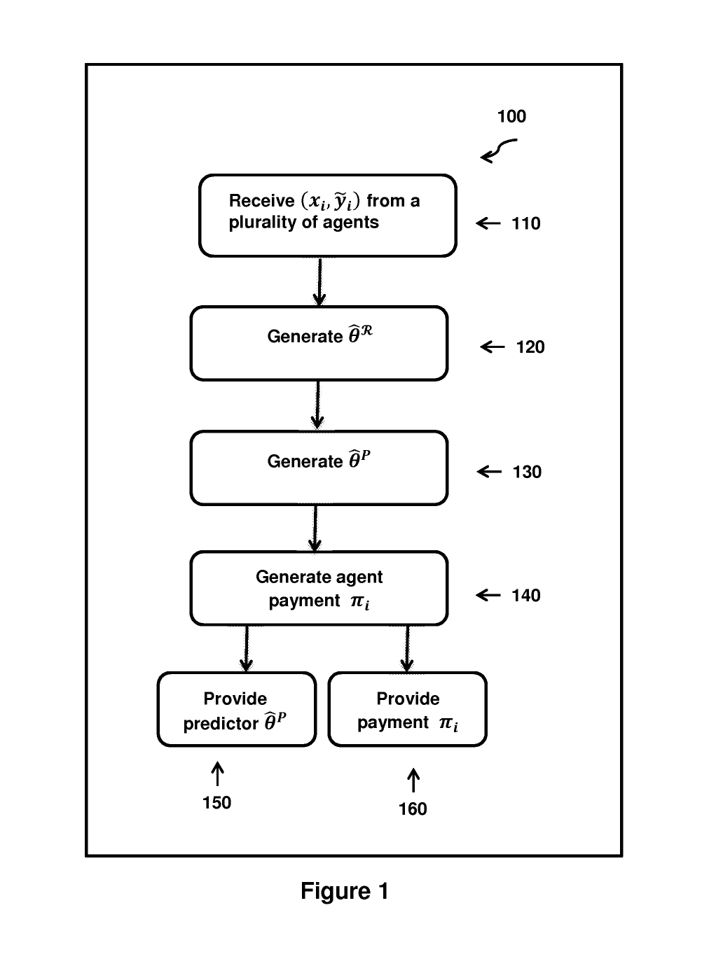

FIG. 1 illustrates a flowchart 100 according to the present principles for a method of generating a privacy-preserving behavior predictor with incentive. The method includes: receiving 110 verifiable and non-verifiable attributes (xᵢ, \tilde{y}ᵢ) for each agent i from a plurality n of agents; generating 120 a first behavior predictor [symbol] ; generating 130 an ε-differentially private behavior predictor \hat{θ}^{P} by adding noise υ to [symbol] ; generating 140 an ε-jointly differentially private payment πᵢ; and providing the ε-jointly differentially private payment πᵢ 150 to each agent i and the ε-differentially-private behavior predictor \hat{θ}^{P} 160.

The first behavior predictor may be based on ridge-regression. The noise may be one of Laplacian, Gaussian and pseudo-random noise. The payment may be of the type: πᵢ=B_{a,b}((\hat{θ}^{P})^{T}xᵢ,E[θ|xᵢ, \tilde{y}ᵢ]^{T}xᵢ), where B_{a,b} is a truthfulness score and E[θ|xᵢ, \tilde{y}ᵢ]^{T} is the expectation of a random predictor θ conditioned on agent i reported attributes. The thruthfulness score may be of the type: B_{a,b}(p, q)=a−b * (p−2pq+q²) where a is a shifting parameter, b is a scaling parameter, q is an indicator variable and p is a probability of the event associated with the indicator.

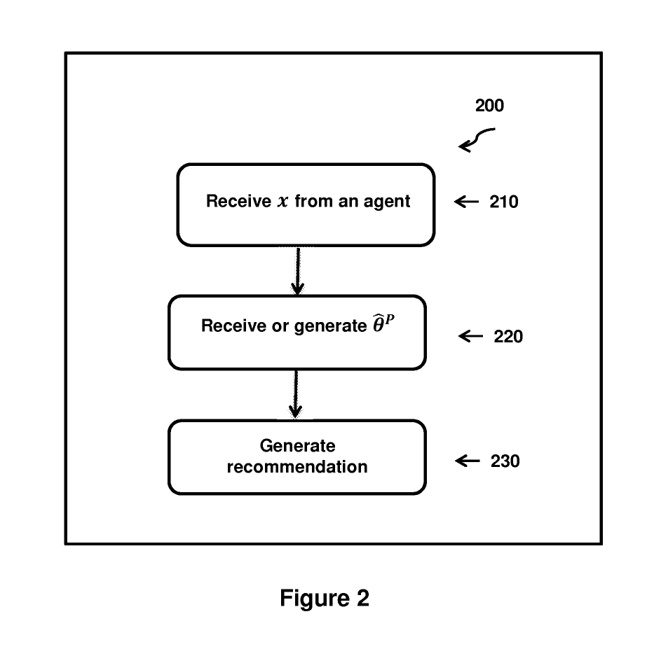

FIG. 2 illustrates a flowchart 200 for a method of recommendation according to the present principles. The method includes: receiving 210 verifiable attributes x from an agent; receiving or generating 220 an ε-differentially private behavior predictor θ=\hat{θ}^{P} according to any of the methods of generating a privacy-preserving behavior predictor with incentive of the present principles (e.g., flowchart 100); and generating a recommendation 230 based on the verifiable attributes and the behavior predictor. The recommendation may be of the type: y=θ^{T}x. It may also be a general function of the verifiable attributes and the behavior predictor, as in y=ƒ(θ, x), where ƒ(. , .) may be non-linear.

It is to be understood that the present principles may be implemented in various forms of hardware, software, firmware, special purpose processors, or a combination thereof. Preferably, the present principles are implemented as a combination of hardware and software. Moreover, the software is preferably implemented as an application program tangibly embodied on a program storage device. The application program may be uploaded to, and executed by, a machine including any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

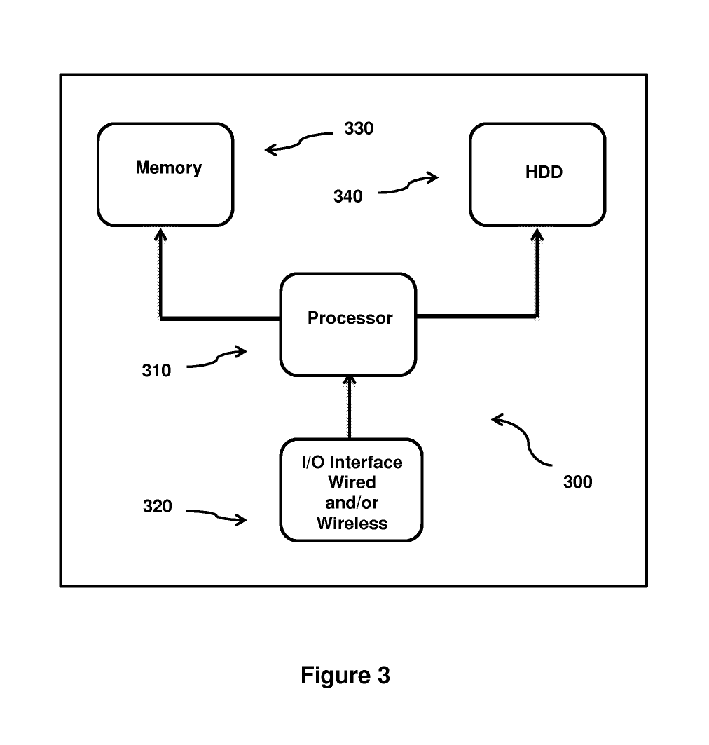

FIG. 3 shows a block diagram of a minimum computing environment 300 used to implement any of the methods of the present principles. The computing environment 300 includes a processor 310, and at least one (and preferably more than one) I/O interface 320. The I/O interface can be wired or wireless and, in the wireless implementation is pre-configured with the appropriate wireless communication protocols to allow the computing environment 300 to operate on a global network (e.g., internet) and communicate with other computers or servers (e.g., cloud based computing or storage servers) so as to enable the present principles to be provided, for example, as a Software as a Service (SAAS) feature remotely provided to end users. One or more memories 330 and/or storage devices (Hard Disk Drive, HDD) 340 are also provided within the computing environment 300.

It is to be further understood that, because some of the constituent system components and method steps depicted in the accompanying figures are preferably implemented in software, the actual connections between the system components (or the process steps) may differ depending upon the manner in which the present principles are programmed. Given the teachings herein, one of ordinary skill in the related art will be able to contemplate these and similar implementations or configurations of the present principles.

Although the illustrative embodiments have been described herein with reference to the accompanying figures, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method of generating a privacy-preserving behavior predictor with incentives, said method performed by an apparatus and comprising:
receiving verifiable and reported non-verifiable attributes for each agent of a plurality of agents;
generating a first behavior predictor based on regression over said attributes;
generating an ε-differentially private behavior predictor by adding noise tosaid first behavior predictor;
generating ε-jointly differentially private payments per agent; and
providing said ε-jointly differentially private payment o each agent and said ε-differentially-private behavior predictor.

2. The method of claim 1, wherein the first behavior predictor is based on ridge-regression.

3. The method of claim 1, wherein the noise is one of Laplacian, Gaussian and pseudo-random noise.

4. The method of claim 1, wherein the payment per agent πᵢ satisfies the equation:
πᵢ=B_{a,b}((\hat{θ}^{P})^{T}xᵢ, E[θ|xᵢ, \tilde{y}ᵢ]^{T}xᵢ)
where i is the agent, B_{a,b} is a truthfulness score and E[θ|xᵢ, \tilde{y}ᵢ]^{T} is the expectation of a random predictor θ conditioned on agent i reported attributes, xᵢ are the verifiable attributes for agent i, \tilde{y}ᵢ are the reported non-verifiable attributes for agent i, and \hat{θ}^{P} is the ε-differentially private behavior predictor.

5. The method of claim 4, wherein the thruthfulness score B_{a,b} satisfies the equation:
B_{a,b}(p, q)=a−b*(p−2pq+q²)
where a is a shifting parameter, b is a scaling parameter, q is an indicator variable and p is a probability of the event associated with said indicator.

6. An apparatus for generating a privacy-preserving behavior predictor with incentives, said apparatus comprising a processor, for receiving at least one input/output; and at least one memory in signal communication with said processor, said processor being configured to:
receive verifiable and reported non-verifiable attributes for each agent of a plurality of agents;
generate a first behavior predictor based on regression over said attributes;
generate an ε-differentially private behavior predictor by adding noise to the first behavior predictor;
generate ε-jointly differentially private payments per agent; and
provide said ε-jointly differentially private payment to each agent and said ε-differentially-private behavior predictor.

7. The apparatus of claim 6, wherein the first behavior predictor is based on ridge-regression.

8. The apparatus of claim 6, wherein the noise is one of Laplacian, Gaussian and pseudo-random noise.

9. The apparatus of claim 6, wherein the payment per agent πᵢ satisfies the equation:
πᵢ=B_{a,b}((\hat{θ}^{P})^{T}xᵢ,E[θ|xᵢ, \tilde{y}ᵢ]^{T}xᵢ)
where i is the agent, B_{a,b} is a truthfulness score and E[θ|xᵢ, \tilde{y}ᵢ]^{T} is the expectation of a random predictor θ and conditioned on agent i reported attributes, xᵢ are the verifiable attributes for agent i, \tilde{y}ᵢ are the reported non-verifiable attributes for agent i, and \hat{θ}^{P} is the ε-differentially private behavior predictor.

10. The apparatus of claim 9, wherein the thruthfulness score B_{a,b} satisfies the equation:
B_{a,b}(p, q)=a−b*(p−2pq+q²)
where a is a shifting parameter, b is a scaling parameter, q is an indicator variable and p is a probability of the event associated with said indicator.

11. A method of recommendation performed by an apparatus, said method comprising:
receiving verifiable attributes x from an agent;
receiving or generating an ε-differentially private behavior predictor with incentive according to claim 1; and
generating a recommendation based on said verifiable attributes and said behavior predictor.

12. The method of claim 11, wherein the said behavior predictor is based on ridge-regression.

13. The method of claim 11, wherein the ε-differential privacy noise is one of Laplacian, Gaussian and pseudo-random noise.

14. The method of claim 11, wherein the incentive per agent πᵢ satisfies the equation:
πᵢ=B_{a,b}((\hat{θ}^{P})^{T}xᵢ, E[θ|xᵢ, \tilde{y}ᵢ]^{T}xᵢ)
where i is the agent, B_{a,b} is a truthfulness score and E[θ|xᵢ, \tilde{y}ᵢ]^{T} is the expectation of a random predictor θ conditioned on agent i reported attributes, xᵢ are the verifiable attributes for agent i, \tilde{y}ᵢ are the reported non-verifiable attributes for agent i, and \hat{θ}^{P} is the ε-differentially private behavior predictor.

15. The method of claim 14, wherein the thruthfulness score B_{a,b} satisfies the equation:
B_{a,b}(p, q)=a−b*(p−2pq+q²)
where a is a shifting parameter, b is a scaling parameter, q is an indicator variable and p is a probability of the event associated with said indicator.

16. An apparatus for generating a recommendation, said apparatus comprising a processor, for receiving at least one input/output; and at least one memory in signal communication with said processor, said processor being configured to:
receive verifiable attributes x from an agent;
receive or generating an ε-differentially private behavior predictor with incentive according to claim 6; and
generating a recommendation based on said verifiable attributes and said behavior predictor.

17. The apparatus of claim 16, wherein the said behavior predictor is based on ridge-regression.

18. The apparatus of claim 16, wherein the ε-differential privacy noise is one of Laplacian, Gaussian and pseudo-random noise.

19. The apparatus of claim 16, wherein the incentive per agent πᵢ satisfies the equation:
πᵢ=B_{a,b}((\hat{θ}^{P})^{T}xᵢ, E[θ|xᵢ, \tilde{y}ᵢ]^{T}xᵢ)
where i is the agent, B_{a,b} is a truthfulness score and E[θ|xᵢ, \tilde{y}ᵢ]^{T} is the expectation of a random predictor θ conditioned on agent i reported attributes, xᵢ are the verifiable attributes for agent i, \tilde{y}ᵢ are the reported non-verifiable attributes for agent i, and \hat{θ}^{P} is the ε-differentially private behavior predictor.

20. The apparatus of claim 19, wherein the thruthfulness score B_{a,b} satisfies the equation:
B_{a,b}(p, q)=a−b*(p−2pq+q²)
where a is a shifting parameter, b is a scaling parameter, q is an indicator variable and p is a probability of the event associated with said indicator.
